(19) United States
(12) Patent Application Publication
(10) Pub. No.: US 2026/0371184 A1
(43) Pub. Date: Nov. 19, 2026

(54) REFERENCE SIGNAL CONFLICT RESOLUTION FOR CARRIER AGGREGATION SWITCHING PATTERN

(71) Applicant: QUALCOMM Incorporated, San Diego, CA (US)

(72) Inventors: Kazuki TAKEDA, Minato-ku (JP); Changhwan PARK, San Diego, CA (US); Nazmul ISLAM, Littleton, MA (US); Jae Ho RYU, San Diego, CA (US); Heechoon LEE, San Diego, CA (US)

(21) Appl. No.: 19/667,211

(22) Filed: May 4, 2026

Related U.S. Application Data
(60) Provisional application No. 63/806,317, filed on May 15, 2025.

(51) Int. Cl. H04W 36/00; H04B 7/06; H04W 72/23

(52) U.S. Cl. CPC H04W 36/00692; H04B 7/0626; H04W 72/23

(57) ABSTRACT

Various aspects of the present disclosure generally relate to wireless communication. In some aspects, a user equipment (UE) may receive a configuration for a switching pattern for carrier aggregation of at least a first carrier and a second carrier, wherein the switching pattern indicates a first set of durations during which the first carrier is active and a second set of durations during which the second carrier is active. The UE may receive a configuration that schedules a reference signal for one or more resources of the second carrier, the one or more resources comprising a set of symbols on the second carrier that includes at least one symbol outside the second set of durations. The UE may refrain from monitoring for the reference signal in the slot on the second carrier in accordance with the set of symbols including the at least one symbol. Numerous other aspects are described.

### CROSS-REFERENCE TO RELATED APPLICATION

This Patent Application claims priority to U.S. Provisional Patent Application No. 63/806,317, filed on May 15, 2025, entitled “REFERENCE SIGNAL CONFLICT RESOLUTION FOR CARRIER AGGREGATION SWITCHING PATTERN,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with reference signal conflict resolution for carrier aggregation switching patterns.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a user equipment (UE) and a network node may exchange one or more reference signals to support communications between the UE and the network node. For example, the network node may transmit one or more downlink reference signals, such as channel state information reference signals, and the UE may monitor the one or more downlink reference signals to obtain channel parameters for subsequent communications with the network node. In some examples, downlink reference signals may be used for maintaining time and frequency synchronization between the UE and the network node. Additionally, or alternatively, some downlink reference signals, such as a tracking reference signal, may be used by the UE to determine or track a position of the UE. Additionally, the UE may transmit one or more uplink reference signals, which the network node may monitor. For example, uplink reference signals may be used for channel estimation, positioning estimation, or channel demodulation, among other examples.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories. The UE may additionally include one or more processors coupled with the one or more memories and configured to cause the UE to receive, from a network node, a configuration for a switching pattern for carrier aggregation of at least a first carrier and a second carrier, wherein the switching pattern indicates a first set of durations during which the first carrier is active and a second set of durations during which the second carrier is active. The one or more processors may be configured to cause the UE to receive, from the network node, a configuration that schedules a reference signal for one or more resources of the second carrier, wherein the one or more resources comprise a set of symbols on the second carrier and the set of symbols includes at least one symbol outside the second set of durations. The one or more processors may be configured to cause the UE to refrain from monitoring for the reference signal in the slot on the second carrier in accordance with the set of symbols including the at least one symbol outside the second set of durations.

Some aspects described herein relate to a network node for wireless communication. The network node may include one or more memories. The network node may additionally include one or more processors coupled with the one or more memories and configured to cause the network node to transmit, to a UE, a configuration for a switching pattern for carrier aggregation of at least a first carrier and a second carrier, wherein the switching pattern indicates a first set of durations during which the first carrier is active and a second set of durations during which the second carrier is active. The one or more processors may be configured to cause the network node to transmit, to the UE, a configuration that schedules a reference signal for one or more resources of the second carrier, wherein the one or more resources occur at least partially outside the second set of durations. The one or more processors may be configured to cause the network node to transmit, to the UE, one or more communications via the second carrier in accordance with the one or more resources occurring at least partially outside the second set of durations.

Some aspects described herein relate to a method of wireless communication performed by a UE. The method may include receiving, from a network node, a configuration for a switching pattern for carrier aggregation of at least a first carrier and a second carrier, wherein the switching pattern indicates a first set of durations during which the first carrier is active and a second set of durations during which the second carrier is active. The method may include receiving, from the network node, a configuration that schedules a reference signal for one or more resources of the second carrier, wherein the one or more resources comprise a set of symbols on the second carrier and the set of symbols includes at least one symbol outside the second set of durations. The method may include refraining from monitoring for the reference signal in the slot on the second carrier in accordance with the set of symbols including the at least one symbol outside the second set of durations.

Some aspects described herein relate to a method of wireless communication performed by a network node. The method may include transmitting, to a UE, a configuration for a switching pattern for carrier aggregation of at least a first carrier and a second carrier, wherein the switching pattern indicates a first set of durations during which the first carrier is active and a second set of durations during which the second carrier is active. The method may include transmitting, to the UE, a configuration that schedules a reference signal for one or more resources of the second carrier, wherein the one or more resources occur at least partially outside the second set of durations. The method may include transmitting, to the UE, one or more communications via the second carrier in accordance with the one or more resources occurring at least partially outside the second set of durations.

Some aspects described herein relate to a non-transitory computer-readable medium that stores a set of instructions for wireless communication by a UE. The set of instructions, when executed by one or more processors of the UE, may cause the UE to receive, from a network node, a configuration for a switching pattern for carrier aggregation of at least a first carrier and a second carrier, wherein the switching pattern indicates a first set of durations during which the first carrier is active and a second set of durations during which the second carrier is active. The set of instructions, when executed by one or more processors of the UE, may cause the UE to receive, from the network node, a configuration that schedules a reference signal for one or more resources of the second carrier, wherein the one or more resources comprise a set of symbols on the second carrier and the set of symbols includes at least one symbol outside the second set of durations. The set of instructions, when executed by one or more processors of the UE, may cause the UE to refrain from monitoring for the reference signal in the slot on the second carrier in accordance with the set of symbols including the at least one symbol outside the second set of durations.

Some aspects described herein relate to a non-transitory computer-readable medium that stores a set of instructions for wireless communication by a network node. The set of instructions, when executed by one or more processors of the network node, may cause the network node to transmit, to a UE, a configuration for a switching pattern for carrier aggregation of at least a first carrier and a second carrier, wherein the switching pattern indicates a first set of durations during which the first carrier is active and a second set of durations during which the second carrier is active. The set of instructions, when executed by one or more processors of the network node, may cause the network node to transmit, to the UE, a configuration that schedules a reference signal for one or more resources of the second carrier, wherein the one or more resources occur at least partially outside the second set of durations. The set of instructions, when executed by one or more processors of the network node, may cause the network node to transmit, to the UE, one or more communications via the second carrier in accordance with the one or more resources occurring at least partially outside the second set of durations.

Some aspects described herein relate to an apparatus for wireless communication. The apparatus may include means for receiving, from a network node, a configuration for a switching pattern for carrier aggregation of at least a first carrier and a second carrier, wherein the switching pattern indicates a first set of durations during which the first carrier is active and a second set of durations during which the second carrier is active. The apparatus may include means for receiving, from the network node, a configuration that schedules a reference signal for one or more resources of the second carrier, wherein the one or more resources comprise a set of symbols on the second carrier and the set of symbols includes at least one symbol outside the second set of durations. The apparatus may include means for refraining from monitoring for the reference signal in the slot on the second carrier in accordance with the set of symbols including the at least one symbol outside the second set of durations.

Some aspects described herein relate to an apparatus for wireless communication. The apparatus may include means for transmitting, to a UE, a configuration for a switching pattern for carrier aggregation of at least a first carrier and a second carrier, wherein the switching pattern indicates a first set of durations during which the first carrier is active and a second set of durations during which the second carrier is active. The apparatus may include means for transmitting, to the UE, a configuration that schedules a reference signal for one or more resources of the second carrier, wherein the one or more resources occur at least partially outside the second set of durations. The apparatus may include means for transmitting, to the UE, one or more communications via the second carrier in accordance with the one or more resources occurring at least partially outside the second set of durations.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating examples of carrier aggregation (CA).

FIG. 3 is a diagram illustrating an example associated with reference signal conflict resolution for CA.

FIG. 4 is a diagram illustrating an example associated with reference signal conflict resolution for CA.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

In some wireless communication systems, carrier aggregation (CA) techniques may be used, which may allow a user equipment (UE) to utilize multiple frequency carriers simultaneously to increase data rates and capacity. Low-band CA, which may involve frequency bands below 1 GHz, may be beneficial for improving communication coverage and performance, such as in scenarios where low-band frequencies offer better propagation characteristics relative to higher-band frequencies. For example, CA techniques may be used to support communications for a UE via a frequency division duplex (FDD) carrier (e.g., an uplink and downlink carrier) and a supplemental downlink (SDL) carrier (e.g., a downlink only carrier). In some cases, however, some UEs may be unable to support simultaneous CA, such as for carriers in low bands. For example, hardware limitations may prevent a UE from simultaneously transmitting or receiving signals on both carriers.

In some examples, a UE may be configured to support CA via carrier switching. For example, the UE may be configured to switch between two carriers, and the UE may switch between communicating on a first carrier (e.g., an SDL carrier) during a first set of one or more slots and communicating on a second carrier (e.g., an FDD carrier) during a second set of one or more slots. In some examples, the UE may receive, from a network node, an indication of a switching pattern. For example, the network node may transmit a bitmap indicating the first set of one or more slots during which the first carrier is active and the second set of one or more slots during which the second carrier is active.

In some examples, the switching pattern may additionally indicate one or more switching gaps. In some examples, a switching gap may be an interval that may allow the UE to adjust radio frequency (RF) components and other hardware for switching between carriers. In some cases, the duration and configuration of the switching gap may account for various factors, such as a switching delay for switching carriers, RF component adjustment durations, and an uplink timing advance. For example, a switching gap for switching from the SDL carrier to the FDD carrier may be larger than a switching gap for switching from the FDD carrier to the SDL carrier to account for a timing advance for an uplink band of the FDD carrier.

Generally, the network node may avoid configuring communications on a carrier during slots where the carrier is inactive or during a switching gap. In some cases, however, one or more reference signals, such as a channel state information (CSI) reference signal (CSI-RS) and a tracking reference signal (TRS), may be configured in a manner that conflicts with the switching pattern (e.g., by the network node via a periodic or semi-periodic configuration). For example, one or more resources of a reference signal configured for a first carrier may at least partially overlap with a switching gap or a slot during which the first carrier is inactive according to the switching pattern. Consequently, the configuration of reference signals that conflicts with the switching gap for CA may cause uncertainty as to whether the UE is to monitor for the reference signal, or as to how the UE is to monitor for other downlink messages via resources that overlap with the reference signal resources when the reference signal partially overlaps with active slots during which the corresponding carrier is active.

Various aspects relate generally to techniques for conflict resolution of reference signal configurations and a carrier aggregation switching pattern. Some aspects more specifically relate to configuring a UE to handle receiving communications in accordance with a switching pattern configuration for CA of a first carrier and a second carrier (e.g., an SDL carrier and an FDD carrier) and conflicting reference signal configurations. In some aspects, a UE may receive, from a network node, a configuration for a switching pattern indicating durations during which the first carrier and second carrier are active, and a configuration scheduling a reference signal on the second carrier for resources that may occur partially or fully outside the active durations indicated for the second carrier in the switching pattern. The UE may be configured to receive communications via the second carrier in accordance with the resources that occur at least partially outside the active durations. For example, the UE may determine whether to monitor or measure reference signals based on whether the reference signals overlap with switching gaps or occur outside the active durations for the second carrier. In some aspects, the UE may refrain from monitoring for and measuring the reference signal when the reference signal is a CSI-RS that fully or partially overlaps with the switching gap or inactive durations, and the UE may refrain from transmitting corresponding CSI reports associated with the CSI-RS. In some aspects, when the reference signal is a TRS, the UE may monitor TRS resources that do not conflict with switching gaps or inactive durations, or the UE may refrain from monitoring any TRS resources. In some aspects, the UE may be configured to receive a downlink message on resources that at least partially overlap with the resources configured for the reference signal. For example, the UE may be configured to apply rate matching to physical downlink shared channel (PDSCH) resources without including the overlapping reference signal resources. Additionally, or alternatively, the UE may receive the PDSCH message over all resources of the PDSCH, including those configured for the reference signal.

Particular aspects of the subject matter described in this disclosure can be implemented to realize one or more of the following potential advantages. By enabling the UE to adaptively handle reference signals overlapping with switching gaps or active durations, the described techniques may reduce inefficiencies and conserve processing resources by avoiding unnecessary monitoring or updating of CSI reports when collisions occur. For example, the UE may avoid conflicts between switching patterns and reference signal scheduling, ensuring that reference signals like CSI-RS are appropriately handled to reduce redundant processing and improve resource utilization. By allowing the UE to monitor non-conflicting TRS resources, the monitoring may be used for tracking purposes, as even a partial monitoring of TRS resources may provide some tracking information, thereby improving channel tracking while conserving memory resources by avoiding unnecessary storage or processing of unusable TRS data. Similarly, by enabling rate matching for PDSCH resources based on the conflicting reference signal resources, the UE may dynamically adapt resource allocation techniques to maintain efficient data reception. Accordingly, the described techniques may improve communication reliability and resource efficiency during carrier aggregation switching, such as in low-band frequency scenarios.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

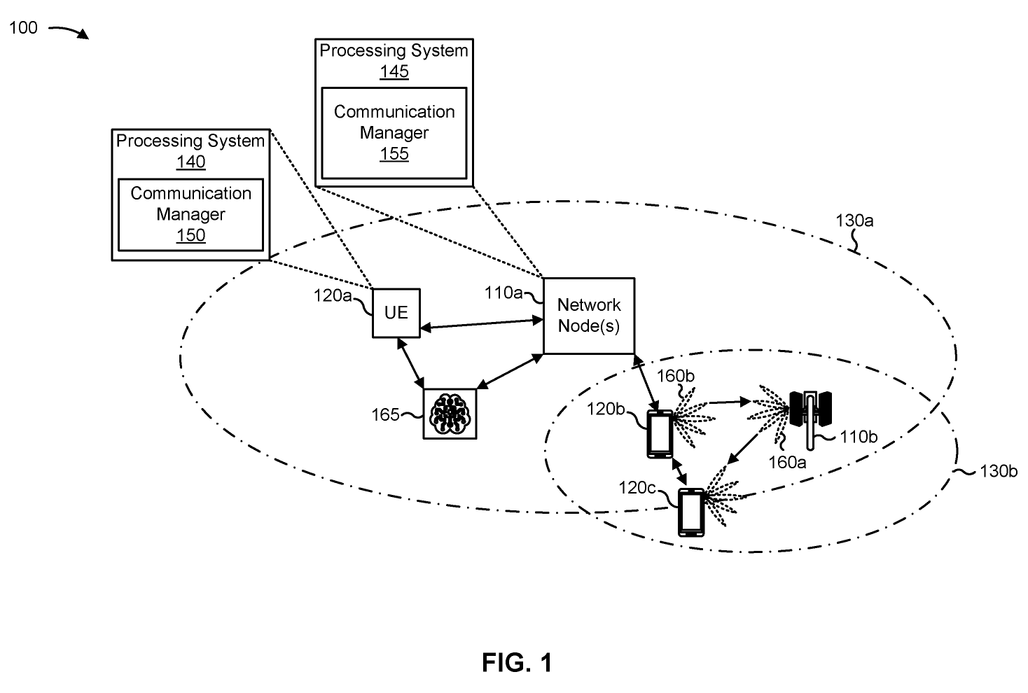

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, a wireless node, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements (REs)), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collect measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node 110, a configuration for a switching pattern for CA of at least a first carrier and a second carrier, wherein the switching pattern indicates a first set of durations during which the first carrier is active and a second set of durations during which the second carrier is active; receive, from the network node 110, a configuration that schedules a reference signal for one or more resources of the second carrier, wherein the one or more resources occur at least partially outside the second set of durations; and receive, from the network node 110, one or more communications via the second carrier in accordance with the one or more resources occurring at least partially outside the second set of durations. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a configuration for a switching pattern for CA of at least a first carrier and a second carrier, wherein the switching pattern indicates a first set of durations during which the first carrier is active and a second set of durations during which the second carrier is active; transmit, to the UE 120, a configuration that schedules a reference signal for one or more resources of the second carrier, wherein the one or more resources occur at least partially outside the second set of durations; and transmit, to the UE 120, one or more communications via the second carrier in accordance with the one or more resources occurring at least partially outside the second set of durations. Additionally, or alternatively, the communication manager 155 may perform one or more other operations described herein.

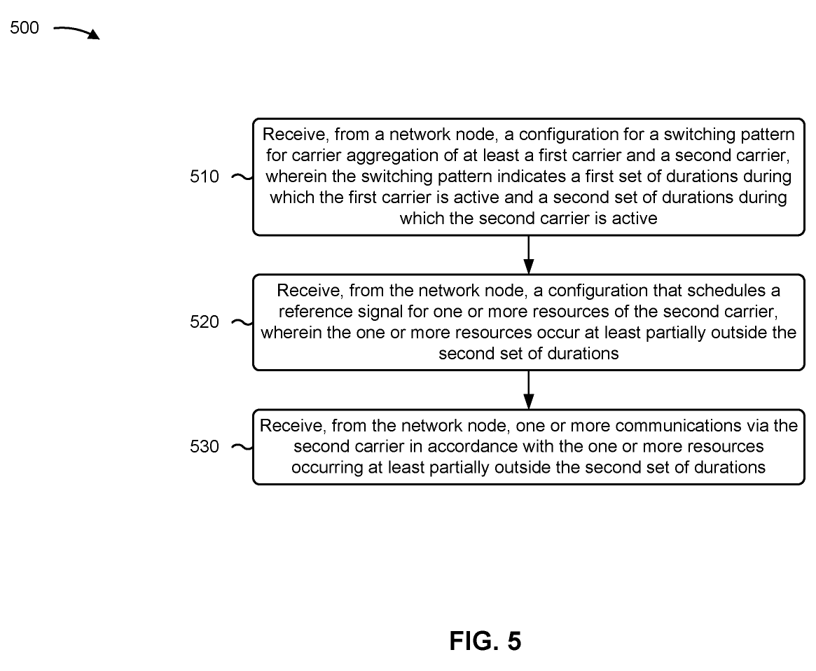

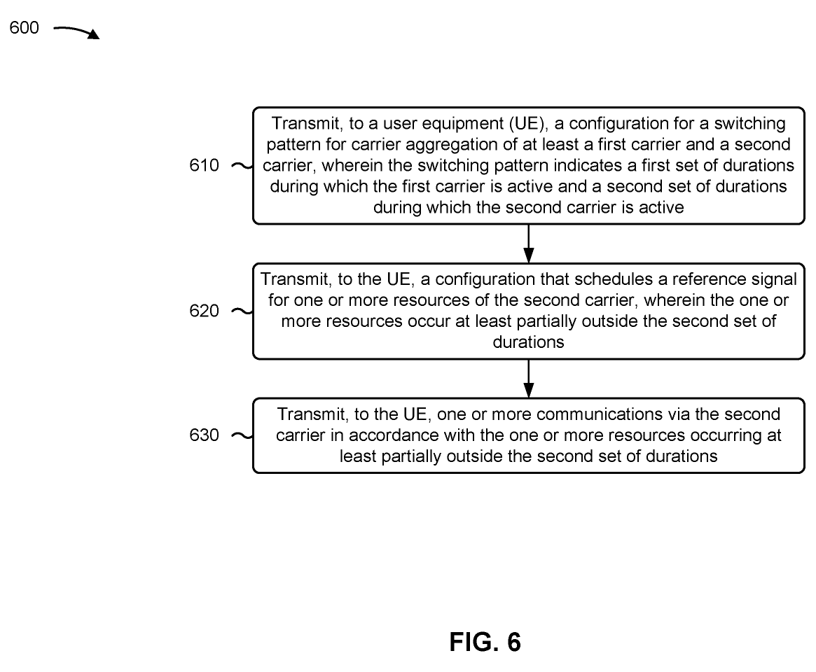

The network node 110, the processing system 145 of the network node 110, the UE 120, the processing system 140 of the UE 120, or any other component(s) of FIG. 1 may implement one or more techniques or perform one or more operations associated with reference signal conflict resolution for CA, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

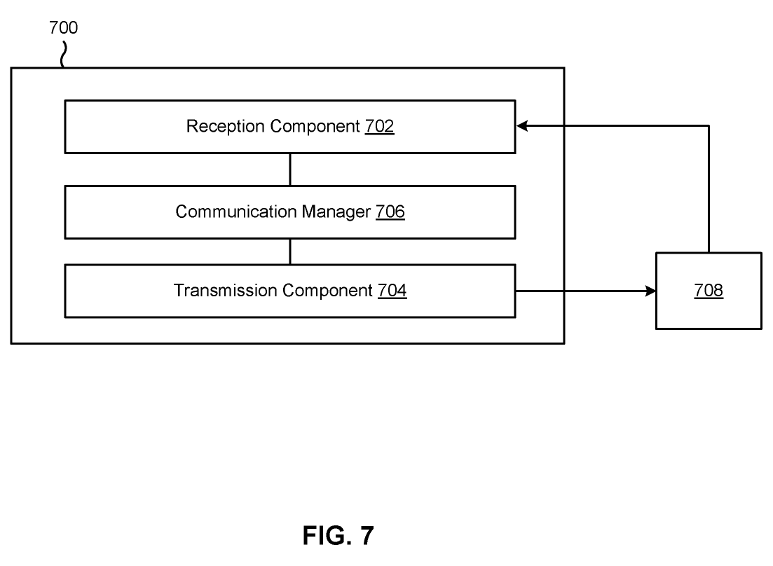

In some aspects, the UE 120 includes means for receiving, from a network node 110, a configuration for a switching pattern for CA of at least a first carrier and a second carrier, wherein the switching pattern indicates a first set of durations during which the first carrier is active and a second set of durations during which the second carrier is active; means for receiving, from the network node 110, a configuration that schedules a reference signal for one or more resources of the second carrier, wherein the one or more resources occur at least partially outside the second set of durations; or means for receiving, from the network node 110, one or more communications via the second carrier in accordance with the one or more resources occurring at least partially outside the second set of durations. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

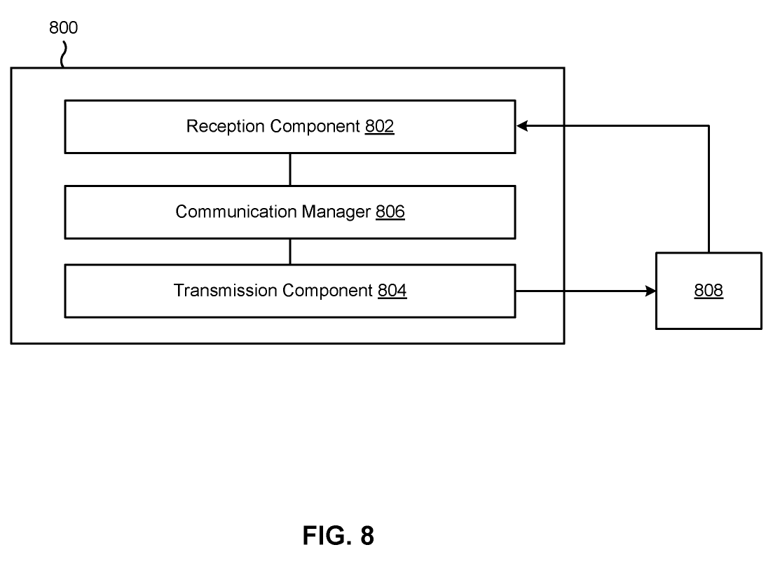

In some aspects, the network node 110 includes means for transmitting, to a UE 120, a configuration for a switching pattern for CA of at least a first carrier and a second carrier, wherein the switching pattern indicates a first set of durations during which the first carrier is active and a second set of durations during which the second carrier is active; means for transmitting, to the UE 120, a configuration that schedules a reference signal for one or more resources of the second carrier, wherein the one or more resources occur at least partially outside the second set of durations; or means for transmitting, to the UE 120, one or more communications via the second carrier in accordance with the one or more resources occurring at least partially outside the second set of durations. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

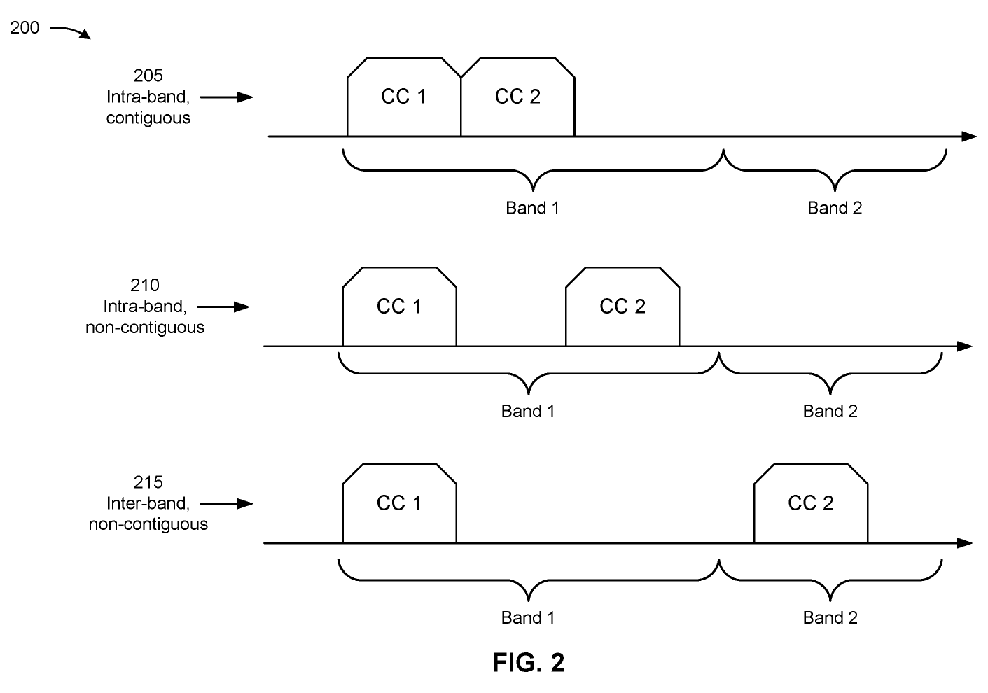

FIG. 2 is a diagram illustrating examples 200 of CA. CA is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure CA for a UE 120, such as in an RRC message, DCI, or another signaling message.

As shown by reference number 205, in some aspects, CA may be configured in an intra-band contiguous mode where the aggregated carriers are contiguous to one another and are in the same band. As shown by reference number 210, in some aspects, CA may be configured in an intra-band non-contiguous mode where the aggregated carriers are non-contiguous to one another and are in the same band. As shown by reference number 215, in some aspects, CA may be configured in an inter-band non-contiguous mode where the aggregated carriers are non-contiguous to one another and are in different bands.

In CA, a UE 120 may be configured with a primary carrier or primary cell (PCell) and one or more secondary carriers or secondary cells (SCells). In some aspects, the primary carrier may carry control information (e.g., downlink control information or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some aspects, the UE 120 may be configured with techniques for conflict resolution of reference signal configurations and a CA switching pattern. For example, the UE 120 may be configured to handle receiving communications in accordance with a switching pattern configuration for CA of a first carrier and a second carrier (e.g., an SDL carrier and an FDD carrier) and conflicting reference signal configurations. In some aspects, the UE 120 may receive, from a network node, a configuration for a switching pattern indicating durations during which the first carrier and second carrier are active, and a configuration scheduling a reference signal on the second carrier for resources that may occur partially or fully outside the active durations indicated for the second carrier in the switching pattern. The UE 120 may be configured to receive communications via the second carrier in accordance with the resources that occur at least partially outside the active durations. For example, the UE 120 may determine whether to monitor or measure reference signals based on whether the reference signals overlap with switching gaps or occur outside the active durations for the second carrier. In some aspects, the UE 120 may refrain from monitoring for and measuring the reference signal when the reference signal is a CSI-RS that fully or partially overlaps with the switching gap or inactive durations, and the UE 120 may refrain from transmitting corresponding CSI reports associated with the CSI-RS. In some aspects, when the reference signal is a TRS, the UE 120 may monitor TRS resources that do not conflict with switching gaps or inactive durations, or the UE 120 may refrain from monitoring any TRS resources. In some aspects, the UE 120 may be configured to receive a downlink message on resources that at least partially overlap with the resources configured for the reference signal. For example, the UE 120 may be configured to apply rate matching to PDSCH resources without including the overlapping reference signal resources. Additionally, or alternatively, the UE 120 may receive the PDSCH message over all resources of the PDSCH, including those configured for the reference signal.

As indicated above, FIG. 2 is provided as an example. Other examples may differ from what is described with regard to FIG. 2.

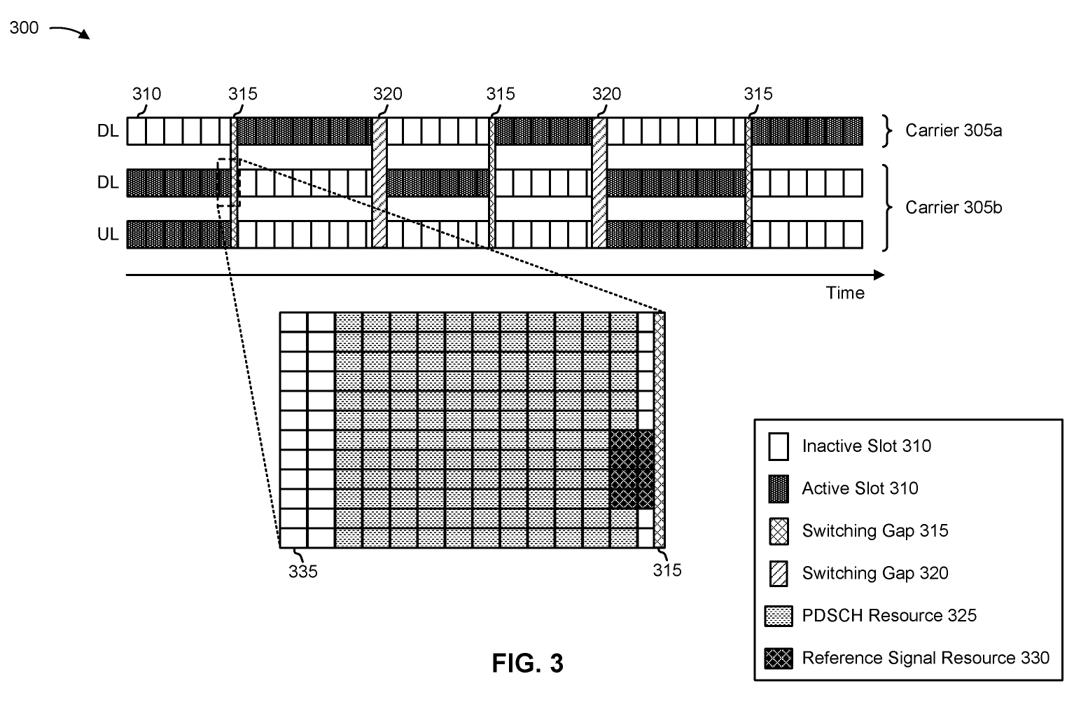

FIG. 3 is a diagram illustrating an example 300 associated with reference signal conflict resolution for CA. As shown in FIG. 3, example 300 illustrates a switching pattern for communications between a network node 110 and a UE 120 via a first carrier 305a and a second carrier 305b. In some examples, the first carrier 305a may be an example of an SDL carrier that supports downlink communications from the network node 110 to the UE 120, and the second carrier 305b may be an example of an FDD carrier that may support both uplink and downlink communications between the network node 110 and the UE 120. In some aspects, the network node 110 and the UE 120 may be included in a wireless network, such as wireless network 100.

In some examples, the network node 110 may transmit, to the UE 120, a configuration indicating the switching pattern for CA. The switching pattern may indicate a first set of slots 310 during which a first carrier 305a is active, and a second set of slots 310 during which a second carrier 305b is active. Additionally, or alternatively, the switching pattern may indicate one or more durations during which slots 310 are active for the first carrier 305a and inactive for the second carrier 305b, and one or more durations during which slots 310 are active for second carrier 305b and inactive for the first carrier 305a. In some cases, the first carrier 305a may be an SDL carrier that supports downlink communications, while the second carrier 305b may be a FDD carrier that supports both uplink and downlink communications.

In some aspects, the switching pattern may include one or more switching gaps. For example, the switching pattern may include one or more switching gaps 351 for transitioning from the second carrier 305b to the first carrier 305a, and one or more switching gaps 320 for transitioning from the first carrier 305a to the second carrier 305b. In some aspects, switching gaps 315 may be a same or a different duration than switching gaps 320. For example, the one or more switching gaps 320 may be of a longer duration than the switching gaps 315, which may support a timing advance configured for uplink communications on the second carrier 305b. Additionally, or alternatively, the duration for each switching gap may be based on adjustments in RF components and other hardware to be made by the UE 120 when switching between carriers 305 to accommodate the transmission requirements of the carriers 305.

In some examples, the network node 110 may transmit a downlink message to the UE 120 via the first carrier 305a and the second carrier 305b via one or more PDSCH resources 325. Additionally, in some cases, the network node 110 may configure one or more reference signal resources 330 for transmission of a reference signal via the first carrier 305a or the second carrier 305b. For example, the network node 110 may configure one or more reference signal resources 330 on the second carrier 305b (e.g., a downlink band of the second carrier 305b) associated with a reference signal. In some examples, the reference signal may be an example of a CSI-RS, which may be scheduled for eight REs 335 of a slot 310 of the carrier 305b (e.g., over two symbols).

In some cases, the one or more reference signal resources 330 on the second carrier 305b may be scheduled for one or more durations during which the second carrier 305b is not active. For example, the one or more reference signal resources 330 may overlap with a switching gap 315 or a slot 310 during which the first carrier 305a is active, leading to a conflict of the reference signal configuration with the switching pattern configured for the UE 120. In some aspects, the UE 120 may be configured with one or more techniques to handle the conflict.

In some examples, when the reference signal resources 330 configured for the reference signal fully or partially overlap with a switching gap 315 or a period during which the second carrier 305b (e.g., the carrier on which the reference signal is configured) is inactive, the UE 120 may be configured to refrain from receiving the reference signal. Accordingly, the UE 120 does not expend unnecessary resources on monitoring reference signals that are not fully within active slots 310 of the second carrier 305b, and the UE 120 may ignore a reference signal that is not fully within active slots 310 of a carrier 305 on which the reference signal is configured. In some cases, the UE 120 may refrain from monitoring the reference signal resources 330 based on the type of reference signal. For example, the UE 120 may be configured to refrain from monitoring for CSI-RSs that fully or partially overlap with a switching gap 315 or a period during which the carrier 305 on which the reference signal is configured is inactive.

In some aspects, when the UE 120 refrains from monitoring a CSI-RS, the UE 120 may additionally refrain from updating CSI associated with the CSI-RS. For example, the network node 110 may configure one or more resources for transmitting a CSI report to report CSI based on monitoring of the CSI-RS. Accordingly, the UE 120 does not transmit the CSI when the CSI-RS is not monitored, due to the conflict with the switching pattern for CA, thereby preventing the incorporation of potentially inaccurate or incomplete data into the CSI report.

In some aspects, the one or more reference signal resources 330 may at least partially overlap with PDSCH resources 325 configured on the second carrier 305b. In some aspects, the UE 120 may be configured to monitor the PDSCH and receive a PDSCH message in accordance with the conflict with the reference signal. For example, when the UE 120 does not monitor for the reference signal, the UE 120 may be configured to perform rate matching for the PDSCH around the CSI-RS resources, excluding them from the available resources for PDSCH reception. For instance, the UE 120 may consider the REs 335 configured as reference signal resources 330 as unavailable, even when the UE 120 does not monitor for the reference signal. Accordingly, the UE 120 may rate match the PDSCH for reception on REs 335 configured as PDSCH resources 325 not including REs 335 that are (e.g., additionally) configured as reference signal resources 330. Similarly, the network node 110 may consider the REs 335 configured as reference signal resources 330 as unavailable for PDSCH transmission (e.g., to be used instead for the reference signal transmission), and the network node 110 may transmit the reference signal on REs 335 configured as PDSCH resources 325 not including REs 335 that are (e.g., additionally) configured as reference signal resources 330.

Alternatively, when the UE 120 does not monitor for the reference signal, the UE 120 may be configured to treat the CSI-RS resources as available for PDSCH reception. For example, the UE 120 may be configured to not rate match around the REs 335 configured as reference signal resources 330. Accordingly, the UE 120 may receive a PDSCH message via the PDSCH on all resources configured as PDSCH resources 325, including resources that are also configured as reference signal resources 330. Similarly, the network node 110 may be configured to transmit the PDSCH messages on REs 335 configured as PDSCH resources 325, including REs 335 that are also configured as reference signal resources 330. For example, the network node 110 may refrain from transmitting the reference signal when the reference signal is configured on the reference signal resources 330 that conflict with the switching pattern.

Accordingly, the UE 120 may receive one or more PDSCH messages via PDSCH resources 325 even when a reference signal is configured to overlap with the PDSCH resources 325. Additionally, the UE 120 may be configured with techniques to handle the reference signal resources 330 conflicting with the switching pattern, thereby reducing ambiguity in communications with the network node 110.

As indicated above, FIG. 3 is provided as an example. Other examples may differ from what is described with respect to FIG. 3. For example, while FIG. 3 shows an example where a reference signal is configured on the second carrier 305b, similar techniques may be applied when the reference signal is configured on the first carrier 305a. Additionally, the configuration of the reference signal resources 330 illustrated in FIG. 3 is provided as an example, and different configurations having different arrangements of REs 335 may be used.

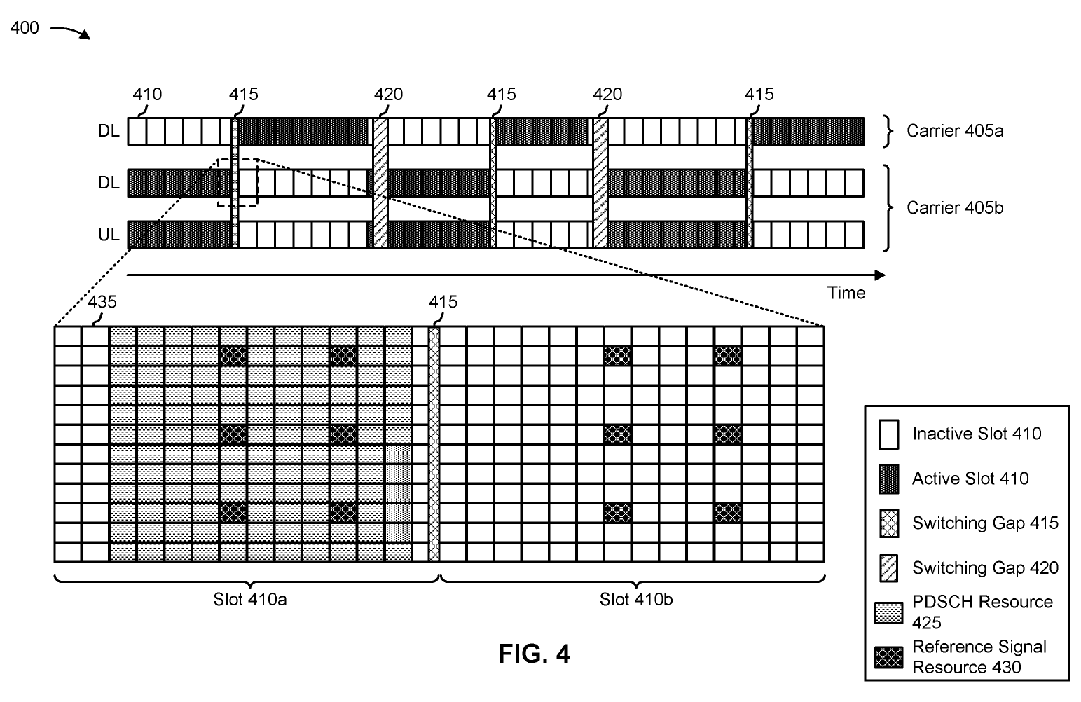

FIG. 4 is a diagram illustrating an example 400 associated with reference signal conflict resolution for CA. As shown in FIG. 4, example 400 illustrates a switching pattern for communications between a network node 110 and a UE 120 via a first carrier 405a and a second carrier 405b. In some examples, the first carrier 405a may be an example of an SDL carrier that supports downlink communications from the network node 110 to the UE 120, and the second carrier 405b may be an example of an FDD carrier that may support both uplink and downlink communications between the network node 110 and the UE 120. In some aspects, the network node 110 and the UE 120 may be included in a wireless network, such as wireless network 100.

In some examples, the network node 110 may configure a switching pattern for carrier aggregation to the UE 120, as described herein. For example, the switching pattern may include or indicate a first set of slots 410 during which a first carrier 405a is active and a second set of slots 410 during which a second carrier 405b is active. The switching pattern may also include one or more switching gaps 415 for transitioning from the second carrier 405b to the first carrier 405a, and one or more switching gaps 420 for transitioning from the first carrier 405a to the second carrier 405b, as described herein. In some cases, the first carrier 405a may be an SDL carrier supporting downlink communications, and the second carrier 405b may be an FDD carrier supporting both uplink and downlink communications.

In some aspects, the network node 110 may configure reference signal resources 430 for transmitting a reference signal on a carrier 405. For example, the network node 110 may transmit a configuration to the UE 120 indicating the reference signal resources 430 for the reference signal on the second carrier 405b. In some examples, the reference signal may be a TRS, which may be configured over two consecutive slots 410, having one or more REs 435 separated by a gap of three REs 435 on each slot 410, as shown in FIG. 4.

In some examples, the reference signal may be configured for the second carrier 405b. In some aspects, when the reference signal fully or partially overlaps with a switching gap or a slot 410 on which the second carrier 405b is inactive, the UE 120 may be configured to refrain from monitoring for the reference signal (e.g., the TRS). Additionally, or alternatively, the UE 120 may be configured to refrain from monitoring the reference signal (e.g., the TRS) when the reference signal fully overlaps with a switching gap or one or more slots 410 when the second carrier 405b is inactive. For example, when the TRS is configured on a carrier 405 for two inactive slots 410 during which the carrier 405 is inactive, the UE 120 does not monitor for the TRS.

In some cases, when one or more PDSCH resources 425 are scheduled on a slot 410 where the reference signal does not conflict with the switching pattern or gap, the UE 120 may consider the REs 435 for the reference signal (e.g., the reference signal resources 430) as unavailable for PDSCH reception, performing rate matching on PDSCH resources 425 around the REs 435 configured as reference signal resources 430, as described herein. Alternatively, the UE 120 may treat the TRS resources as available for PDSCH reception, and may receive one or more PDSCH messages via all REs 435 configured as PDSCH resources 425, including those additionally configured as reference signal resources 430, as described herein.

Additionally, or alternatively, when the reference signal at least partially overlaps with the switching pattern and one or more reference signal resources 430 are located during an active duration of the second carrier 405b (e.g., on one or more active slots 410), the UE 120 may be configured to monitor for at least a portion of the reference signal. For example, when a reference signal spans a first slot 410a on which the second carrier 405b is active and a second slot 410b on which the second carrier 405b is inactive, the UE 120 may monitor for the signal on reference signal resources 430 configured for the first slot 410a, while refraining from receiving the reference signal on reference signal resources 430 configured for the second slot 410b. Accordingly, the UE 120 may at least partially receive the reference signal even when the reference signal conflicts with the switching pattern.

In some aspects, the UE 120 may be configured to partially monitor for a reference signal based on a type of the reference signal. For example, a TRS may still provide useful information for positioning determination at the UE 120 even when the TRS is only partially monitored (e.g., in contrast to a CSI-RS or other reference signals which may not provide useful information when partially monitored). Accordingly, the UE 120 may partially monitor for some reference signals, such as TRSs, when the corresponding reference signal resources 430 occur at least partially during an active duration of the corresponding carrier 405.

As indicated above, FIG. 4 is provided as an example. Other examples may differ from what is described with respect to FIG. 4. For example, while FIG. 4 shows an example where a reference signal is configured on the second carrier 405b, similar techniques may be applied when the reference signal is configured on the first carrier 405a. Additionally, the configuration of the reference signal resources 430 illustrated in FIG. 4 is provided as an example, and different configurations having different arrangements of REs 435 are possible.

FIG. 5 is a diagram illustrating an example process 500 performed, for example, at a UE or an apparatus of a UE. Example process 500 is an example where the apparatus or the UE (e.g., UE 120) performs operations associated with reference signal conflict resolution for CA switching patterns.

As shown in FIG. 5, in some aspects, process 500 may include receiving, from a network node, a configuration for a switching pattern for CA of at least a first carrier and a second carrier, wherein the switching pattern indicates a first set of durations during which the first carrier is active and a second set of durations during which the second carrier is active (block 510). For example, the UE (e.g., using reception component 702 or communication manager 706, depicted in FIG. 7) may receive, from a network node, a configuration for a switching pattern for CA of at least a first carrier and a second carrier, wherein the switching pattern indicates a first set of durations during which the first carrier is active and a second set of durations during which the second carrier is active, as described above.

As further shown in FIG. 5, in some aspects, process 500 may include receiving, from the network node, a configuration that schedules a reference signal for one or more resources of the second carrier, wherein the one or more resources occur at least partially outside the second set of durations (block 520). For example, the UE (e.g., using reception component 702 or communication manager 706, depicted in FIG. 7) may receive, from the network node, a configuration that schedules a reference signal for one or more resources of the second carrier, wherein the one or more resources occur at least partially outside the second set of durations, as described above.

As further shown in FIG. 5, in some aspects, process 500 may include receiving, from the network node, one or more communications via the second carrier in accordance with the one or more resources occurring at least partially outside the second set of durations (block 530). For example, the UE (e.g., using reception component 702 or communication manager 706, depicted in FIG. 7) may receive, from the network node, one or more communications via the second carrier in accordance with the one or more resources occurring at least partially outside the second set of durations, as described above.

Process 500 may include additional aspects, such as any single aspect or any combination of aspects described below or in connection with one or more other processes described elsewhere herein.

In a first aspect, a first portion of the one or more resources occurs inside the second set of durations and a second portion of the one or more resources occurs outside the second set of durations.

In a second aspect, alone or in combination with the first aspect, receiving the one or more communications includes receiving a PDSCH message via the second carrier in accordance with rate matching a set of resources of the PDSCH message that do not include the first portion of the one or more resources.

In a third aspect, alone or in combination with one or more of the first and second aspects, receiving the one or more communications includes receiving a PDSCH message via the second carrier including the first portion of the one or more resources.

In a fourth aspect, alone or in combination with one or more of the first through third aspects, process 500 includes refraining from monitoring for the reference signal in accordance with the one or more resources occurring at least partially outside the second set of durations.

In a fifth aspect, alone or in combination with one or more of the first through fourth aspects, process 500 includes refraining from transmitting a CSI report associated with the reference signal, wherein the reference signal comprises a CSI-RS.

In a sixth aspect, alone or in combination with one or more of the first through fifth aspects, the switching pattern includes one or more switching gaps for switching between communications via a first set of resources of the first carrier to communications via a second set of resources of the second carrier.

In a seventh aspect, alone or in combination with one or more of the first through sixth aspects, the one or more resources occur at least partially during a first switching gap of the one or more switching gaps.

In an eighth aspect, alone or in combination with one or more of the first through seventh aspects, process 500 includes refraining from monitoring for the reference signal in accordance with the one or more resources occurring at least partially during the first switching gap.

In a ninth aspect, alone or in combination with one or more of the first through eighth aspects, receiving the one or more communications includes monitoring for the reference signal during a portion of the one or more resources in accordance with the portion of the reference signal occurring during the second set of durations.

In a tenth aspect, alone or in combination with one or more of the first through ninth aspects, monitoring for the reference signal is in accordance with the reference signal comprising a TRS.

In an eleventh aspect, alone or in combination with one or more of the first through tenth aspects, the first carrier is a supplementary downlink carrier configured for downlink communications, and the second carrier is a frequency division duplex carrier configured for uplink and downlink communications.

In a twelfth aspect, alone or in combination with one or more of the first through eleventh aspects, the first carrier is a frequency division duplex carrier configured for uplink and downlink communications, and the second carrier is a supplementary downlink carrier configured for downlink communications.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with reference signal conflict resolution for CA switching pattern.

As shown in FIG. 6, in some aspects, process 600 may include transmitting, to a UE, a configuration for a switching pattern for CA of at least a first carrier and a second carrier, wherein the switching pattern indicates a first set of durations during which the first carrier is active and a second set of durations during which the second carrier is active (block 610). For example, the network node (e.g., using transmission component 804 or communication manager 806, depicted in FIG. 8) may transmit, to a UE, a configuration for a switching pattern for CA of at least a first carrier and a second carrier, wherein the switching pattern indicates a first set of durations during which the first carrier is active and a second set of durations during which the second carrier is active, as described above.

As further shown in FIG. 6, in some aspects, process 600 may include transmitting, to the UE, a configuration that schedules a reference signal for one or more resources of the second carrier, wherein the one or more resources occur at least partially outside the second set of durations (block 620). For example, the network node (e.g., using transmission component 804 or communication manager 806, depicted in FIG. 8) may transmit, to the UE, a configuration that schedules a reference signal for one or more resources of the second carrier, wherein the one or more resources occur at least partially outside the second set of durations, as described above.

As further shown in FIG. 6, in some aspects, process 600 may include transmitting, to the UE, one or more communications via the second carrier in accordance with the one or more resources occurring at least partially outside the second set of durations (block 630). For example, the network node (e.g., using transmission component 804 or communication manager 806, depicted in FIG. 8) may transmit, to the UE, one or more communications via the second carrier in accordance with the one or more resources occurring at least partially outside the second set of durations, as described above.

Process 600 may include additional aspects, such as any single aspect or any combination of aspects described below or in connection with one or more other processes described elsewhere herein.

In a first aspect, a first portion of the one or more resources occurs inside the second set of durations and a second portion of the one or more resources occurs outside the second set of durations.

In a second aspect, alone or in combination with the first aspect, transmitting the one or more communications includes transmitting a PDSCH message via the second carrier in accordance with rate matching a set of resources of the PDSCH message that do not include the first portion of the one or more resources.

In a third aspect, alone or in combination with one or more of the first and second aspects, transmitting the one or more communications includes transmitting a PDSCH message via the second carrier including the first portion of the one or more resources.

In a fourth aspect, alone or in combination with one or more of the first through third aspects, the switching pattern includes one or more switching gaps for switching between communications via a first set of resources of the first carrier to communications via a second set of resources of the second carrier.

In a fifth aspect, alone or in combination with one or more of the first through fourth aspects, the one or more resources occur at least partially during a first switching gap of the one or more switching gaps.

In a sixth aspect, alone or in combination with one or more of the first through fifth aspects, the first carrier is a supplementary downlink carrier configured for downlink communications, and the second carrier is a frequency division duplex carrier configured for uplink and downlink communications.

In a seventh aspect, alone or in combination with one or more of the first through sixth aspects, the first carrier is a frequency division duplex carrier configured for uplink and downlink communications, and the second carrier is a supplementary downlink carrier configured for downlink communications.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE (e.g., a UE 120), or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 2-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from a network node (e.g., a network node 110), a configuration for a switching pattern for CA of at least a first carrier and a second carrier, wherein the switching pattern indicates a first set of durations during which the first carrier is active and a second set of durations during which the second carrier is active. The reception component 702 may receive, from the network node, a configuration that schedules a reference signal for one or more resources of the second carrier, wherein the one or more resources occur at least partially outside the second set of durations. The reception component 702 may receive, from the network node, one or more communications via the second carrier in accordance with the one or more resources occurring at least partially outside the second set of durations.

The communication manager 706 may refrain from monitoring for the reference signal in accordance with the one or more resources occurring at least partially outside the second set of durations.

The communication manager 706 may refrain from transmitting a CSI report associated with the reference signal, wherein the reference signal comprises a CSI-RS.

The communication manager 706 may refrain from monitoring for the reference signal in accordance with the one or more resources occurring at least partially during the first switching gap.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 2-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a UE (e.g., a UE 120), a configuration for a switching pattern for CA of at least a first carrier and a second carrier, wherein the switching pattern indicates a first set of durations during which the first carrier is active and a second set of durations during which the second carrier is active. The transmission component 804 may transmit, to the UE, a configuration that schedules a reference signal for one or more resources of the second carrier, wherein the one or more resources occur at least partially outside the second set of durations. The transmission component 804 may transmit, to the UE, one or more communications via the second carrier in accordance with the one or more resources occurring at least partially outside the second set of durations.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: receiving, from a network node, a configuration for a switching pattern for CA of at least a first carrier and a second carrier, wherein the switching pattern indicates a first set of durations during which the first carrier is active and a second set of durations during which the second carrier is active; receiving, from the network node, a configuration that schedules a reference signal for one or more resources of the second carrier, wherein the one or more resources occur at least partially outside the second set of durations; and receiving, from the network node, one or more communications via the second carrier in accordance with the one or more resources occurring at least partially outside the second set of durations.

Aspect 2: The method of Aspect 1, wherein a first portion of the one or more resources occurs inside the second set of durations and a second portion of the one or more resources occurs outside the second set of durations.

Aspect 3: The method of Aspect 2, wherein receiving the one or more communications includes: receiving a PDSCH message via the second carrier in accordance with rate matching a set of resources of the PDSCH message that do not include the first portion of the one or more resources.

Aspect 4: The method of Aspect 2, wherein receiving the one or more communications includes: receiving a PDSCH message via the second carrier including the first portion of the one or more resources.

Aspect 5: The method of any of Aspects 1-4, further comprising: refraining from monitoring for the reference signal in accordance with the one or more resources occurring at least partially outside the second set of durations.

Aspect 6: The method of Aspect 5, further comprising: refraining from transmitting a CSI report associated with the reference signal, wherein the reference signal comprises a CSI-RS.

Aspect 7: The method of any of Aspects 1-6, wherein the switching pattern includes one or more switching gaps for switching between communications via a first set of resources of the first carrier to communications via a second set of resources of the second carrier.

Aspect 8: The method of Aspect 7, wherein the one or more resources occur at least partially during a first switching gap of the one or more switching gaps.

Aspect 9: The method of Aspect 8, further comprising: refraining from monitoring for the reference signal in accordance with the one or more resources occurring at least partially during the first switching gap.

Aspect 10: The method of any of Aspects 1-4 or 7-8, wherein receiving the one or more communications includes: monitoring for the reference signal during a portion of the one or more resources in accordance with the portion of the reference signal occurring during the second set of durations.

Aspect 11: The method of Aspect 10, wherein monitoring for the reference signal is in accordance with the reference signal comprising a TRS.

Aspect 12: The method of any of Aspects 1-11, wherein the first carrier is a supplementary downlink carrier configured for downlink communications, and the second carrier is a frequency division duplex carrier configured for uplink and downlink communications.

Aspect 13: The method of any of Aspects 1-11, wherein the first carrier is a frequency division duplex carrier configured for uplink and downlink communications, and the second carrier is a supplementary downlink carrier configured for downlink communications.

Aspect 14: A method of wireless communication performed by a network node, comprising: transmitting, to a UE, a configuration for a switching pattern for CA of at least a first carrier and a second carrier, wherein the switching pattern indicates a first set of durations during which the first carrier is active and a second set of durations during which the second carrier is active; transmitting, to the UE, a configuration that schedules a reference signal for one or more resources of the second carrier, wherein the one or more resources occur at least partially outside the second set of durations; and transmitting, to the UE, one or more communications via the second carrier in accordance with the one or more resources occurring at least partially outside the second set of durations.

Aspect 15: The method of Aspect 14, wherein a first portion of the one or more resources occurs inside the second set of durations and a second portion of the one or more resources occurs outside the second set of durations.

Aspect 16: The method of Aspect 15, wherein transmitting the one or more communications includes: transmitting a PDSCH message via the second carrier in accordance with rate matching a set of resources of the PDSCH message that do not include the first portion of the one or more resources.

Aspect 17: The method of Aspect 15, wherein transmitting the one or more communications includes: transmitting a PDSCH message via the second carrier including the first portion of the one or more resources.

Aspect 18: The method of any of Aspects 14-17, wherein the switching pattern includes one or more switching gaps for switching between communications via a first set of resources of the first carrier to communications via a second set of resources of the second carrier.

Aspect 19: The method of any of Aspects 14-18, wherein the one or more resources occur at least partially during a first switching gap of the one or more switching gaps.

Aspect 20: The method of any of Aspects 14-19, wherein the first carrier is a supplementary downlink carrier configured for downlink communications, and the second carrier is a frequency division duplex carrier configured for uplink and downlink communications.

Aspect 21: The method of any of Aspects 14-19, wherein the first carrier is a frequency division duplex carrier configured for uplink and downlink communications, and the second carrier is a supplementary downlink carrier configured for downlink communications.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 23: An apparatus for wireless communication at a device, the apparatus comprising one or more memories and one or more processors coupled to the one or more memories, the one or more processors configured to cause the device to perform the method of one or more of Aspects 1-21.

Aspect 24: An apparatus for wireless communication, the apparatus comprising at least one means for performing the method of one or more of Aspects 1-21.

Aspect 25: A non-transitory computer-readable medium storing code for wireless communication, the code comprising instructions executable by one or more processors to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

Aspect 27: A device for wireless communication, the device comprising a processing system that includes one or more processors and one or more memories coupled with the one or more processors, the processing system configured to cause the device to perform the method of one or more of Aspects 1-21.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

Aspect 29: A device comprising a processing system that includes one or more processors and one or more code-storing memories coupled with the one or more processors, the processing system configured to cause the device to perform the method of one or more of Aspects 1-21.

Aspect 30: A device comprising a processing system that includes processor circuitry and code-storing memory circuitry, the processing system configured to cause the device to perform the method of one or more of Aspects 1-21.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled with the one or more memories and configured to cause the UE to:
receive, from a network node, a configuration for a switching pattern for carrier aggregation of at least a first carrier and a second carrier, wherein the switching pattern indicates a first set of durations during which the first carrier is active and a second set of durations during which the second carrier is active;
receive, from the network node, a configuration that schedules a reference signal for one or more resources of the second carrier, wherein the one or more resources comprise a set of symbols on the second carrier and the set of symbols includes at least one symbol outside the second set of durations; and
refrain from monitoring for the reference signal in the slot on the second carrier in accordance with the set of symbols including the at least one symbol outside the second set of durations.

2. The UE of claim 1, wherein a first portion of the one or more resources occurs inside the second set of durations and a second portion of the one or more resources occurs outside the second set of durations.

3. The UE of claim 2, wherein the one or more processors are configured to cause the UE to:
receive a physical downlink shared channel (PDSCH) message via the second carrier in accordance with rate matching a set of resources of the PDSCH message that do not include the first portion of the one or more resources.

4. The UE of claim 2, wherein the one or more processors are configured to cause the UE to:
receive a physical downlink shared channel (PDSCH) message via the second carrier including the first portion of the one or more resources.

5. The UE of claim 1, wherein the one or more processors are further configured to cause the UE to:
refrain from transmitting a channel state information (CSI) report associated with the reference signal, wherein the reference signal comprises a CSI reference signal (CSI-RS).

6. The UE of claim 1, wherein the switching pattern includes one or more switching gaps for switching between communications via a first set of resources of the first carrier to communications via a second set of resources of the second carrier.

7. The UE of claim 6, wherein the one or more resources occur at least partially during a first switching gap of the one or more switching gaps.

8. The UE of claim 7, wherein the one or more processors are further configured to cause the UE to refrain from monitoring for the reference signal in accordance with the one or more resources occurring at least partially during the first switching gap.

9. The UE of claim 1, wherein the reference signal comprises a tracking reference signal.

10. The UE of claim 1, wherein the first carrier is a supplementary downlink carrier configured for downlink communications, and the second carrier is a frequency division duplex carrier configured for uplink and downlink communications.

11. The UE of claim 1, wherein the first carrier is a frequency division duplex carrier configured for uplink and downlink communications, and the second carrier is a supplementary downlink carrier configured for downlink communications.

12. A method of wireless communication performed by a user equipment (UE), comprising:
receiving, from a network node, a configuration for a switching pattern for carrier aggregation of at least a first carrier and a second carrier, wherein the switching pattern indicates a first set of durations during which the first carrier is active and a second set of durations during which the second carrier is active;
receiving, from the network node, a configuration that schedules a reference signal for one or more resources of the second carrier, wherein the one or more resources comprise a set of symbols on the second carrier and the set of symbols includes at least one symbol outside the second set of durations; and
refraining from monitoring for the reference signal in the slot on the second carrier in accordance with the set of symbols including the at least one symbol outside the second set of durations.

13. The method of claim 12, wherein a first portion of the one or more resources occurs inside the second set of durations and a second portion of the one or more resources occurs outside the second set of durations.

14. The method of claim 13, further comprising:
receiving a physical downlink shared channel (PDSCH) message via the second carrier in accordance with rate matching a set of resources of the PDSCH message that do not include the first portion of the one or more resources.

15. The method of claim 13, further comprising:
receiving a physical downlink shared channel (PDSCH) message via the second carrier including the first portion of the one or more resources.

16. The method of claim 12, further comprising:
refraining from transmitting a channel state information (CSI) report associated with the reference signal, wherein the reference signal comprises a CSI reference signal (CSI-RS).

17. The method of claim 12, wherein the switching pattern includes one or more switching gaps for switching between communications via a first set of resources of the first carrier to communications via a second set of resources of the second carrier.

18. The method of claim 17, wherein the one or more resources occur at least partially during a first switching gap of the one or more switching gaps.

19. The method of claim 12, wherein the reference signal comprises a tracking reference signal.

20. A non-transitory computer-readable medium storing a set of instructions for wireless communication, the set of instructions comprising:
one or more instructions that, when executed by one or more processors of a user equipment (UE), cause the UE to:
receive, from a network node, a configuration for a switching pattern for carrier aggregation of at least a first carrier and a second carrier, wherein the switching pattern indicates a first set of durations during which the first carrier is active and a second set of durations during which the second carrier is active;
receive, from the network node, a configuration that schedules a reference signal for one or more resources of the second carrier, wherein the one or more resources comprise a set of symbols on the second carrier and the set of symbols includes at least one symbol outside the second set of durations; and
refrain from monitoring for the reference signal in the slot on the second carrier in accordance with the set of symbols including the at least one symbol outside the second set of durations.
